(19) United States
(12) Patent Application Publication
(10) Pub. No.: US 2018/0138840 A1
(43) Pub. Date: May 17, 2018

(54) BRUSHLESS DIRECT CURRENT MOTOR

(71) Applicant: Brose Fahrzeugteile GmbH & Co. Kommanditgesellschaft, Wuerzburg, Wuerzburg (DE)

(72) Inventors: Dirk JOACHIMSMEYER, Hausen (DE); Maxim KRONEWALD, Bad Mergentheim (DE)

(21) Appl. No.: 15/570,221

(22) PCT Filed: May 23, 2016
(86) PCT No.: PCT/EP2016/061534

§ 371 Date: Oct. 27, 2017

(30) Foreign Application Priority Data
Jun. 1, 2015 (DE) 10 2015 108 617.4

(51) Int. Cl. H02P 6/15; H02P 25/03

(52) U.S. Cl. CPC H02P 6/153; H02P 6/16; H02P 25/03

(57) ABSTRACT

It is provided a brushless direct current motor having a stator that comprises a plurality of armature coils, a permanently excited rotor that can rotate with respect to the stator about an axis of rotation and comprises at least two unlike permanent magnetic poles that generate an exciter field that can be described by an exciter field vector and a control unit for controlling the armature coils so as to generate an armature field that rotates at the stator about the axis of rotation and can be described by an armature field vector. The control device is configured so as during the operation of the direct current motor to control the armature coils in such a manner that an angle is set between the armature field vector and the exciter field vector. The control unit comprises a storage unit that stores a characteristic field.

### CROSS-REFERENCE TO A RELATED APPLICATION

This application is a National Phase Patent Application of International Patent Application Number PCT/EP2016/061534, filed on May 23, 2016, which claims priority of German Patent Application Number 10 2015 108 617.4, filed on Jun. 1, 2015, the contents of both of which are incorporated herein by reference.

### BACKGROUND

The invention relates to a brushless direct current motor.

A direct current motor of this type comprises a stator that supports a plurality of armature coils. A rotor can rotate with respect to the stator about an axis of rotation, wherein the rotor is permanently excited and for this purpose comprises at least two unlike permanent magnetic poles that generate an exciter field that can be described by means of an exciter field vector. In addition, the direct current motor comprises a control unit that is used to control the armature coils of the stator in order during the operation of the direct current motor to generate at the armature coils an armature field that rotates at the stator about the axis of rotation and can be described by means of an armature field vector.

During the operation of the direct current motor, an angle is present between the exciter field vector and the armature field vector and said angle can be controlled by means of the control unit. In general, (in the case of idealized conditions), a maximum torque is produced at the rotor if the angle between the armature field vector and the exciter field vector is 90°. The control unit can be used to control this angle, as is described by way of example in DE 693 19 818 T2.

In the case of brushless direct current motors, the commutation procedure is either a sensor-controlled commutation procedure or a sensorless commutation procedure. In general, in the case of brushless direct current motors, the rotating armature field that is generated at the stator is electronically commutated in dependence upon the rotor position, the rotor rotational speed and the torque. The electronic commutation procedure can be used to control the operating behavior of the direct current motor.

The sensor-controlled commutation procedure (so-called sensor-controlled brushless direct current motors) involves sensors, such as by way of example Hall sensors for ascertaining the magnetic flux of the rotor or optical sensors in the region of the stator. The sensors provide information relating to the rotor position that is consequently ascertained by means of a sensor. It is subsequently possible to configure the electronic commutation procedure in dependence upon the rotor position that has been ascertained by means of a sensor.

In the case of the sensorless commutation procedure (so-called sensorless brushless direct current motors), the rotor position is ascertained by means of the reverse voltage that is induced in the armature coils of the stator and that can be evaluated by the control unit so as to determine the rotor position which is possible at least above a specific minimum rotational speed of the direct current motor. In order to start up the direct current motor, it is sometimes necessary to switch the commutation procedure into an idle mode until the minimum rotational speed has been achieved.

When direct current motors are being used, it is desirable to optimize the angle between the armature field vector and the exciter field vector in order to achieve a favorable operating behavior. In general, it may be desirable to operate the direct current motor with a high degree of efficiency. However, it may likewise also be desirable to optimize the direct current motor with respect to its acoustic behavior or its electromagnetic radiation (within the scope of the electromagnetic compatibility, in short EMC). By way of example, a direct current motor can comprise in one rotational speed range a resonance behavior that increases the amount of noise produced in a rotational speed range and this resonance behavior should be avoided where possible.

U.S. Pat. No. 5,886,489 discloses a brushless direct current motor, wherein the rotor position can be measured using a Hall effect sensor. In the case of this motor, the commutation angle is changed until a point is achieved where the degree of efficiency is optimized.

U.S. Pat. No. 4,356,437 discloses a brushless direct current motor that uses Hall sensors to ascertain the rotor position. The motor is controlled in such a manner that the degree of efficiency increases and the acoustic behavior is improved.

In the case of such brushless direct current motors, it may also be desired to subsequently adjust or change the operating behavior of the motor in order to optimize the operating behavior with respect to specific criteria. It would be desirable in this case for a user to be able to predetermine by way of example a specific operating behavior in order by way of example to optimize the efficiency of the motor or to optimize the acoustic behavior by the motor.

### SUMMARY

An object of the present invention is to provide a brushless direct current motor that renders it possible during operation to optimize the operating behaviour of the motor with respect to different criteria, in particular with respect to the efficiency, the acoustic behaviour and the electromagnetic radiation, and that at the same time can be adjusted in a variable manner by a user.

This object is achieved by means of a subject matter having features as described herein.

Accordingly, the control unit comprises a storage unit that stores a characteristic field, wherein angle parameters are stored in the characteristic field and the control unit is configured so as during operation with reference to the characteristic field to control the angle between the armature field vector and the exciter field vector in dependence upon the rotational speed and the torque of the rotor.

The present invention is based on the idea of controlling the angle between the armature field vector and the exciter field vector with reference to a characteristic field that is stored in a storage unit of the control unit. The characteristic field can store by way of example an offset angle for predetermined combinations of rotational speed or torque with the result that it is possible for the control unit to read out an allocated offset angle for a specific rotational speed-torque combination that occurs during operation or that it is possible to determine said allocated offset angle in any other way with reference to the characteristic field. This offset angle is added (electrically) to a reference angle, by way of example 90°, in order to obtain the angle that is to be set between the armature field vector and the exciter field vector. The control unit commutates the current that is introduced into the armature coils so as subsequently to generate the armature field in a controlled manner in such a manner that the desired angle is set.

It is preferred that the characteristic field is in the format of a two dimensional matrix. It is preferred that angle parameters for predetermined combinations of rotational speed and torque are stored in this matrix, wherein it is possible to plot angle parameters against the torque along a first axis and to plot angle parameters against the rotational speed along a second axis. During operation, it is possible for the control unit with reference to the rotational speed and the torque of the rotor to read out an allocated angle parameter value, by way of example an offset angle, in order to determine on the basis of said value the angle that is to be set between the armature field vector and the exciter field vector.

The control unit is advantageously configured so as to determine the rotational speed and the torque of the rotor during the operation of the direct current motor. In the case of a sensor-controlled brushless direct current motor, the rotational speed can be determined with reference to the rotor position that has been ascertained by means of a sensor. In the case of a sensorless brushless direct current motor, the rotor position is determined with reference to the induced reverse voltage. The rotational speed is subsequently derived from the time derivative of the rotor position. In contrast, the torque is proportional to the motor current that creates the torque and can also be determined using measurement technology. In particular, the active power contributes to the torque (whereas the idle power does not contribute to the torque) and can be determined by way of example with reference to a model. The torque can be calculated by way of example using the following equation:

$$M = \frac{3}{2} \cdot p \cdot Ψ \cdot {i}_{q}$$

wherein M represents the torque, p the number of pole pairs, Ψ represents the flux constants and i_{q} represents the torque-creating current along the q-axis.

It is preferred that angle parameters for predetermined combinations of rotational speed and torque are stored in the characteristic field in a two dimensional matrix format. However, in general, a torque and a rotational speed that do not exactly correspond to a rotational speed-torque combination that is stored in the characteristic field are set during the operation of the motor. In order to determine an angle parameter value for a specific rotational speed-torque combination that is produced during the operation of the motor, it is thus possible to provide that an angle parameter value is determined by means of interpolation with reference to the grid points stored in the characteristic field for the torque and the rotational speed.

The angle parameters that are stored in the characteristic field can render it possible to optimize the operating behavior of the direct current motor with reference to different criteria. This optimization procedure can be different in different torque/rotational speed ranges, with the result that the direct current motor can be optimized in one rotational speed range with respect to its efficiency but in another rotational speed range with respect to its acoustic behavior. In this manner, it is possible by optimizing the angle between the armature field vector and the exciter field vector in an appropriate manner to prevent a resonant noise developing, by way of example in a rotational speed range in which if the angle is not optimized a resonance of the motor would occur.

The requirements with respect to optimization can vary depending upon the application of the direct current motor. On the one hand, it may be desired to optimize the direct current motor exclusively with respect to its efficiency, in particular if the acoustic behavior of the motor plays only a subordinate role and it is not regarded as disturbing if a noise develops. However, in another application, it may be desired to prevent the development of excess noise. In order consequently to be able to adjust the direct current motor to suit variably different conditions and applications, it is possible to provide that the characteristic field can be programmed, in other words can be adjusted in a variable manner by a user. For this purpose, angle parameter values that are stored in the characteristic field can be adjusted in a variable manner by means of a suitable program interface, or it is possible to provide that the characteristic field as a whole can be replaced.

In addition or as an alternative thereto, it is also possible to provide that different characteristic fields are stored in the storage unit of the control unit and said different characteristic fields optimize the operating behavior of the motor differently with respect to different criteria, wherein a user is able to make a selection from these different characteristic fields in order in this manner to obtain by way of example an operating behavior that is optimized with respect to efficiency or an operating behavior that is optimized both to efficiency and acoustic behavior.

A suitable characteristic field can be determined by way of example in an empirical manner based on measurements by a motor manufacturer and said characteristic field can be stored in the storage unit. During the subsequent operation, the characteristic field can be used, wherein a user can re-program said characteristic field if the user wishes to adjust the operating behavior in a specific manner.

It is fundamentally conceivable to use the present invention both for sensor-controlled brushless direct current motors and also for sensorless brushless direct current motors. However, in an advantageous manner, the present invention is suitable in particular for the operation of sensorless brushless direct current motors in which the rotor position is determined in a sensorless manner but by means of evaluating the reverse voltage that is induced in the armature coils during the operation of the motor.

A direct current motor of type described here can be used in particular for blowers that are used in the interior of the vehicle. Such interior blowers are to be quiet—in particular in the latest vehicles that comprise an automatic start-stop system. In particular, noises from the blower motors are not to be audible (for example if the vehicle is switched off). Direct current motors of the type described here can consequently be used by way of example to drive fan impellers in such interior blowers.

### BRIEF DESCRIPTION OF THE DRAWINGS

The fundamental idea of the invention is to be further explained hereinunder with reference to the exemplary embodiments illustrated in the figures.

FIG. 1 illustrates a schematic view of a brushless direct current motor.

FIG. 2 illustrates a schematic view of the brushless direct current motor showing an armature field vector and an exciter field vector.

FIG. 3A is a diagrammatic illustration of the torque plotted against the angle between the armature field vector and the exciter field vector showing a marking in the case of an angle of 90° (electrical).

FIG. 3B is an illustration in accordance with

FIG. 3A showing a marking in the case of an angle of 90° (electrical) plus an offset angle.

FIG. 4 is a view of the brushless direct current motor showing an angle between the armature field vector and the exciter field vector where the angle is not 90° (electrical).

FIG. 5 is a view of a characteristic field for controlling the angle.

FIG. 6 is a three dimensional view of the angle parameter that is stored in the characteristic field plotted against the torque and the rotational speed.

FIG. 7 illustrates a graph of the acoustic behavior of the motor plotted against the rotational speed where the offset angle has not been optimized and where the offset angle has been optimized.

FIG. 8 illustrates a graph of the efficiency of the motor plotted against the torque where the offset angle has not been optimized and where the offset angle has been optimized.

FIG. 9 illustrates a graph of the electromagnetic radiation plotted against the frequency where the offset angle has not been optimized and where the offset angle has been optimized.

### DETAILED DESCRIPTION

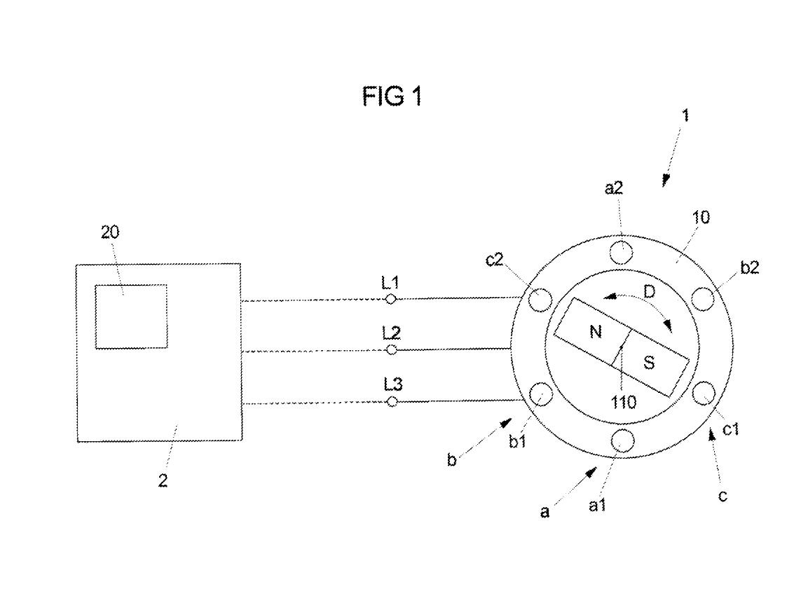

FIG. 1 illustrates a schematic view of a brushless direct current motor 1 that can perform the procedure of determining the rotor position in particular in a sensorless manner and consequently is configured as a sensorless brushless direct current motor.

In the case of one brushless direct current motor 1, a rotor 11 can rotate with respect to a stator 10 about an axis of rotation 110. The rotor 11 supports at least two permanent magnetic poles N, S and is consequently permanently excited. In contrast, the stator 10 supports a plurality of armature coils a-c, in this case three armature coils.

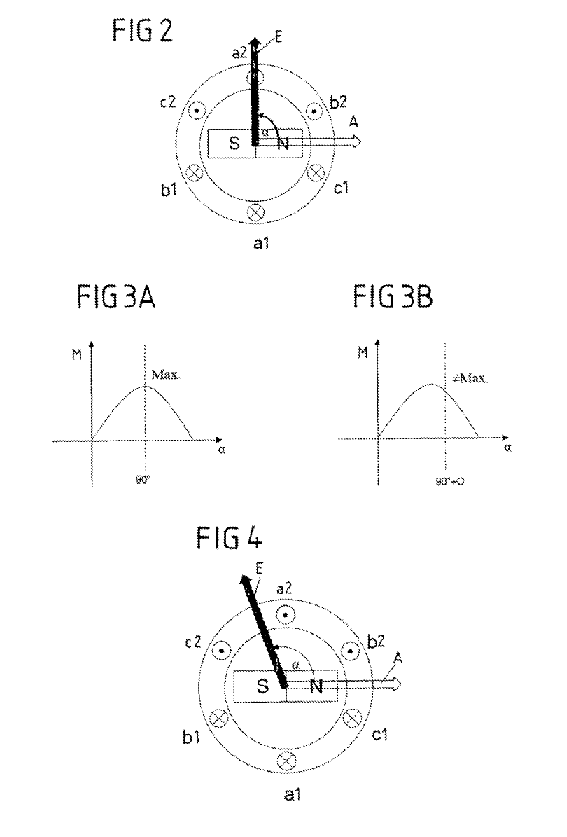

The armature coils a-c comprise in each case, schematically illustrated, a plurality of windings that can be wound by way of example about a stator pole tooth and are indicated in the schematic illustration in accordance with FIG. 2 by means of the coil conductors a1, a2, b1, b2, c1, c2.

In general, the brushless direct current motor 1 comprises 2N permanent magnetic poles on the rotor 11 and three or more armature coils 11 on the stator 10.

During the operation of the motor 1, a current is applied to the armature coils a-c in order to generate in this manner an armature field at the stator 10. The current flux in the armature coils a-c is electronically commutated using a control unit 2 in such a manner that a rotating armature field is produced about the stator 10, the rotor 11 follows this rotation and as a result the rotor 11 performs a rotational movement D about the axis of rotation 110.

During the operation of the motor 1, the armature coils a-c are controlled in a manner offset in terms of time across three phases L1, L2, L3 in order to generate the armature field that is rotating at stator 10. In the case of sensorless brushless direct current motors, two phases L1-L3 by way of example are energized, whereas the third phase L1-L3 is used as a measurement line and is used so as to ascertain a reverse voltage that is induced in the allocated armature coils a-c. This reverse voltage can be evaluated in order to determine the rotor position of the rotor 11 and to control the operation of the motor 1 with reference to the rotor position.

As is illustrated schematically in FIG. 2, an angle α is present between the armature field and the exciter field during the operation of the motor 1. The armature field that is generated at the stator 10 by means of the armature coils a-c can be described by means of an armature field vector A, whereas the exciter field that is generated by means of the permanent magnetic poles N, S of the rotor 11 is described by means of an exciter field vector E.

In the case of idealized conditions, a maximum torque is produced in the case of such a brushless direct current motor where the angle α between the armature field vector A and the exciter field vector E is 90°. This is illustrated in FIGS. 3A and 3B in which the torque is plotted against the angle α. The torque is maximum where the angle α=90° (reference is made in each case to the electrical angle) (see FIG. 3A). If on the other hand the angle α is ≠90°, an offset angle is therefore added to the reference angle of 90° and as a result fundamentally a smaller torque is produced (see FIG. 3B).

If the angle α has a value other than 90° because an offset angle has been added to the reference angle of 90° , this results in the situation illustrated in FIG. 4 in which the exciter field vector E has an angle α≠90° with respect to the armature field vector A.

The present invention is based on the knowledge that the angle α can be optimized in order to influence the operating behavior of the motor 1 with respect to different criteria. The angle α can thus be optimized in order to achieve optimum efficiency of the motor 1. Or the angle α can be optimized in order to improve the acoustic behavior of the motor 1 or to reduce electromagnetic radiation.

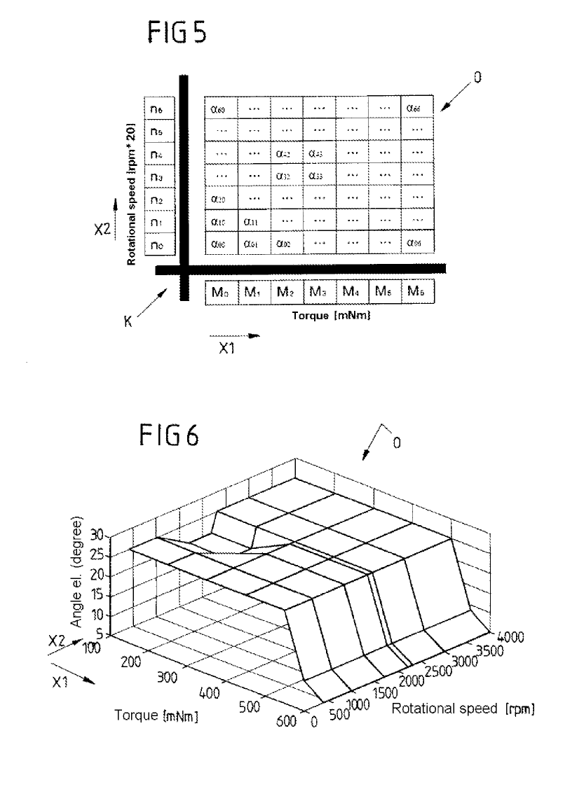

The angle α is controlled in the case of the illustrated exemplary embodiment with reference to a characteristic field K, as is illustrated by way of example in FIG. 5. The characteristic field K has angle parameter values that indicate an offset angle o that is to be added to the reference angle of 90° C. These offsets angle O are illustrated by way of example in the form of a graph in FIG. 6 and have values between 0° and 30°, wherein other in particular also negative values are also possible.

The angle parameter values relating to the torque M and the rotational speed n of the rotor 11 are stored in the characteristic field K. The characteristic field K is stored in a storage unit 20 (see FIG. 1) of the control unit 2. During the operation of the motor 1, the control unit 2 determines the torque M and the rotational speed n of the rotor 11 and with reference to the prevailing torque-rotational speed combination determines the angle parameter value that is to be added to the reference value of 90° in order to obtain a desired operating behavior for the prevailing torque-rotational speed combination.

The characteristic field K stores angle parameter values for predetermined discrete combinations of torque M and rotational speed n. Grid points M0-M6 for the torque M are plotted along an axis X1 (corresponding to the horizontal axis in FIG. 5), whereas grid points n0-n6 for the rotational speed are plotted along a second axis X2 (corresponding to the vertical axis in FIG. 5). During operation, the control unit 2 reads out an allocated angle parameter value for a prevailing torque-rotational speed combination and adds this value to the reference angle of 90° with the result that the angle α is produced and it is with respect to this angle that the rotor position 11 is to be controlled relative to the rotating armature field. The current that is fed into the armature coils a, c is subsequently commutated in a correspondingly controlled manner.

In general, the prevailing rotational speed n and the torque M deviate from the grid points M0-M6, n0-n6 of the characteristic field K. In order to obtain an angle parameter value for a specific torque-rotational speed combination, interpolation is performed between the stored angle parameter values. If the prevailing torque is by way of example between the torque grid points M2 and M3 and if the prevailing specific rotational speed is between the rotational speed grid points n3 and n4, it follows that interpolation will be performed between the allocated angle parameter values α32, α33, α42, α43 in order to obtain the angle parameter value that is subsequently used for the control procedure.

The control procedure can be performed in different operating ranges with reference to the characteristic field K and with reference to different criteria. As a result, the operating behavior of the motor 1 can generally be controlled in such a manner that the efficiency of the motor 1 is optimized. It is possible in specific ranges, by way of example in a specific rotational speed range, to select angle parameter values that are stored in the characteristic field K in such a manner that the acoustic behavior is optimized as a result.

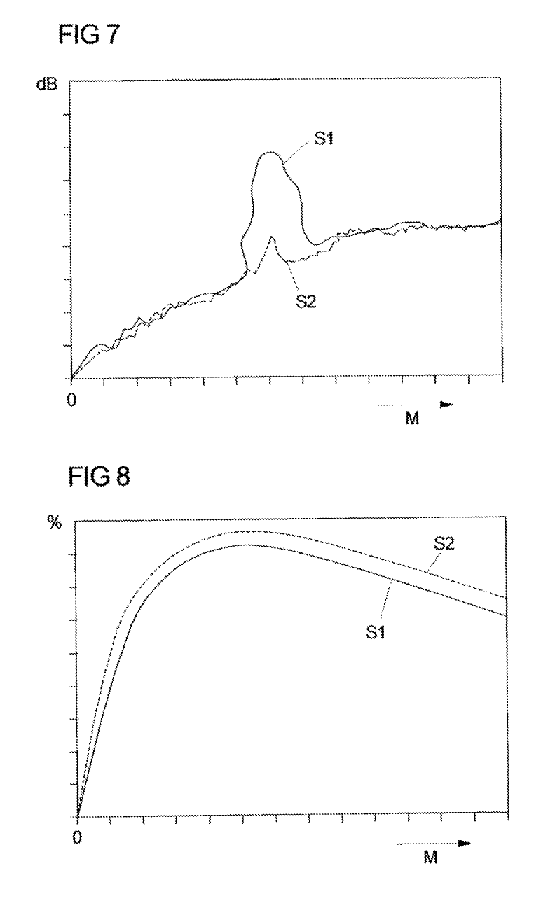

It is possible by way of example that a motor 1 has a resonance behavior in a specific rotational speed range, in other words the mechanical vibration stimulation at the motor 1 increases in a specific rotational speed range. This is illustrated schematically in FIG. 7. The curve S1 illustrates a resonance behavior that demonstrates an increased acoustic behavior in a specific rotational speed range. By virtue of optimizing the offset angle, this resonance behavior can be suppressed, with the result that, as illustrated by the curve S2—in the rotational speed range in which—where the offset angle has not been optimized—a resonance behavior was observed, the acoustic stimulation was not particularly increased.

In addition or as an alternative thereto, the characteristic field K can optimize the efficiency of the motor 1. FIG. 8 illustrates schematically the efficiency of the motor 1 (in percentage) plotted against the torque M. The efficiency can be improved by optimizing the offset angle O, as illustrated by the curve S2.

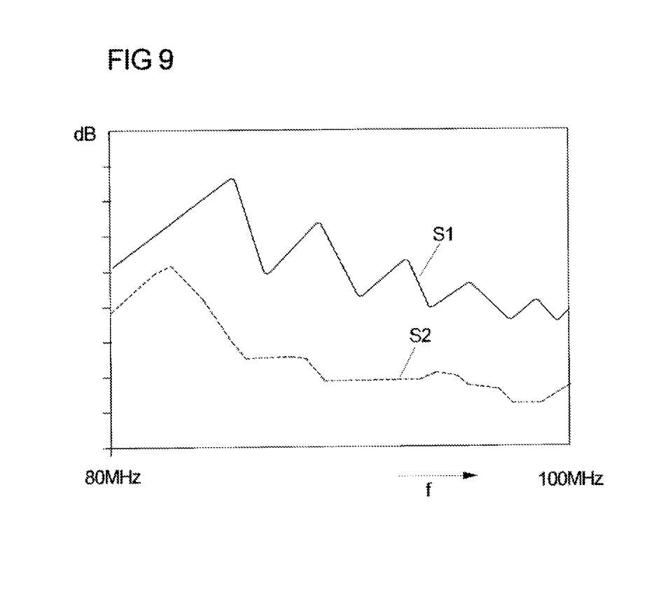

It is also possible in addition or as an alternative to achieve optimization with respect to the electromagnetic radiation. In this case, in particular in a radio frequency range that corresponds by way of example to the UKW range (between 80 MHz and 110 MHz), the electromagnetic radiation of a motor 1 is to be below a predetermined limit value. As illustrated schematically in FIG. 9, the electromagnetic radiation can be reduced by optimizing the offset angle (curve S2) in contrast to a non-optimized offset angle (curve S1).

It is possible to provide that the characteristic curve K can be freely programmed by a user. A user can consequently modify the characteristic field K in such a manner that the motor 1 behaves during operation in a manner as desired by a user. The characteristic field K can be programmed by virtue of the fact that the user can modify individual angle parameter values of the characteristic field K or can replace the characteristic field K as a whole by another characteristic field.

It is also conceivable and possible that multiple characteristic fields K are stored in the storage unit 20 of the control unit 2 and the user can make a selection from said characteristic fields. It is thus possible for a first characteristic field to result in the optimization in particular with respect to the efficiency, whereas a second characteristic field results in the optimization in particular with respect to the acoustic behavior and a third characteristic field results in the optimization with respect to the electromagnetic radiation.

The idea that forms the basis of the invention is not limited to the above described exemplary embodiments but rather it can be realized in general also in a completely different way.

The present invention can be used fundamentally in the case of sensor-controlled brushless direct current motors and also in the case of sensorless brushless direct current motors. The control procedure is performed by a control unit with reference to the rotor position that has been ascertained by means of a sensor (in the case of a sensor-controller commutation procedure) or with reference to a rotor position that has been determined from an induced reverse voltage (in the case of a sensorless commutation procedure).

### List of Reference Numerals

1 Brushless direct current motor
10 Stator
11 Rotor
110 Axis of rotation
2 Control unit
D Rotational movement
A Armature field vector
a,b,c Armature coil
a1,a2,b1,b2,c1,c2 Coil conductor
α Angle
E Exciter field vector
K Characteristic field
L1, L2, L3 Phase
n Rotational speed
M Torque
O Offset
S1, S2 Curve
X1, X2 Axis

1. A brushless direct current motor having:
a stator that comprises a plurality of armature coils,
a permanently excited rotor that can rotate with respect to the stator about an axis of rotation and comprises at least two unlike permanent magnetic poles that generate an exciter field that can be described by an exciter field vector,
a control unit for controlling the armature coils so as to generate an armature field that rotates at the stator about the axis of rotation and can be described by an armature field vector,
wherein the control device is configured so as during the operation of the direct current motor to control the armature coils in such a manner that an angle is set between the armature field vector and the exciter field vector,
wherein the control unit comprises a storage unit that stores a characteristic field, wherein angle parameters are stored in the characteristic field and the control unit is configured so as during operation with reference to the characteristic field to control the angle between the armature field vector and the exciter field vector in dependence upon the rotational speed and the torque of the rotor.

2. The direct current motor as claimed in claim 1, wherein the angle parameters indicate in each case an offset angle that is to be added to a reference angle.

3. The direct current motor as claimed in claim 1, wherein the characteristic field is in the format of a two dimensional matrix in which angle parameters for predetermined combinations of rotational speed and torque of the rotor are stored.

4. The direct current motor as claimed in claim 3, wherein the angle parameters are stored in the characteristic field along a first axis against the torque and along a second axis against the rotational speed.

5. The direct current motor as claimed in claim 1, wherein the control unit is configured so as during the operation of the direct current motor to determine the rotational speed and the torque of the rotor and with reference to the rotational speed and the torque to determine from the characteristic field an allocated angle parameter value.

6. The direct current motor as claimed in claim 5, wherein the control unit is configured so as to determine the angle parameter value by means of interpolation between the angle parameters that are stored in the characteristic field.

7. The direct current motor as claimed in claim 1, wherein with reference to the angle parameter the operating behaviour of the direct current motor is optimized with respect to the acoustic behaviour of the motor, the motor efficiency or the electromagnetic emission.

8. The direct current motor as claimed in claim 1, wherein the characteristic field can be programmed.

9. The direct current motor as claimed in claim 1, wherein the direct current motor performs the procedure of determining the rotor position in a sensorless manner.
